(19) United States
(12) Patent Application Publication
(10) Pub. No.: US 2025/0050272 A1
(43) Pub. Date: Feb. 13, 2025

(54) GAS PROCESSING MODULE, GAS PROCESSING METHOD AND GAS-PHASE ORGANIC COMPOUND PROCESSING METHOD

(71) Applicant: GREENFILTEC LTD., Taoyuan City (TW)

(72) Inventors: Yi-Hui YU, Taoyuan City (TW); Kuo-Min PENG, Taoyuan City (TW); Yu-De LIEN, Taoyuan City (TW); Ju-Ting LEE, Taoyuan City (TW)

(73) Assignee: GREENFILTEC LTD., Taoyuan City (TW)

(21) Appl. No.: 18/799,777

(22) Filed: Aug. 9, 2024

Related U.S. Application Data
(60) Provisional application No. 63/532,153, filed on Aug. 11, 2023.
(60) Provisional application No. 63/569,297, filed on Mar. 25, 2024.

(51) Int. Cl. B01D 53/88; B01D 53/86; B01D 53/96

(52) U.S. Cl. CPC B01D 53/885; B01D 53/8668; B01D 53/96; B01D 2255/20707; B01D 2255/802; B01D 2257/7027; B01D 2257/708; B01D 2258/0216; B01D 2259/804

(57) ABSTRACT

The present invention provides a gas processing module, a gas processing method and a gas-phase organic compound processing method. A gas processing module comprises a cavity, a gas input unit, a light source, a photocatalyst, a liquid input unit, a gas discharge unit and a liquid discharge unit. The gas input unit is communicated with the inside of the cavity and used for supplying a to-be-processed gas comprising a gas-phase organic compound into the cavity. The light source is arranged in the cavity and used for providing a first light. The photocatalyst is arranged in the cavity, and at least a portion of the gas-phase organic compound of the to-be-processed gas which comes into contact with the photocatalyst generates an organic compound product under the action of the photocatalyst when irradiated by the first light. The liquid input unit is communicated with the inside of the cavity and used for providing a solvent to come into contact with the surface of the photocatalyst, and the organic compound product can be dissolved into the solvent.

### CROSS-REFERENCE TO RELATED APPLICATIONS

This non-provisional application claims the benefit under 35 U.S.C. § 119 (c) to U.S. Provisional Application No. 63/569,297, filed on Mar. 25, 2024, and U.S. Provisional Application No. 63/532,153, filed on Aug. 11, 2023, all of which are hereby expressly incorporated by reference into the present application.

### TECHNICAL FIELD

The present invention relates to a gas processing module, a gas processing method and a gas-phase organic compound processing method. More specifically, the present invention relates to a gas processing module, gas processing method and gas-phase organic compound processing method for removing airborne molecular contaminants (AMC) containing volatile organic compounds (VOC) in semi-conductor industry related processes.

### BACKGROUND

In the field of industrial manufacturing, such as semiconductor manufacturing industry, to further promote the yield of a product, a clean room is widely used in clean and pollution-free isolation environments for production manufacturing of products.

To achieve the environment requirements on the clean room, a fan and a filter device are erected at a gas inlet of the clean room so that a gas flow passes through a filter screen of the filter device under the drive of the fan to enter the clean room so as to filter dusts and various organic and inorganic pollutants.

For volatile organic compounds (VOC) in airborne molecular contaminants (AMC), such as benzene, acetone, isopropanol, ethyl acetate, dimethyl sulfoxide, ethanolamine, propylene glycol methyl ether and propylene glycol methyl ether acetate, one of the common removal methods is to use activated carbon materials for adsorption. Where, the activated carbon materials have a good physical adsorption effect on alkane, alkene, ether and benzene compounds in VOC through their holes, but have a poor physical adsorption effect on alcohol, ketone, acid and ester compounds in VOC, and therefore a method for reaction processing by virtue of a photocatalyst is provided. However, when the photocatalyst is used for reaction processing in the conventional technology, the product can be accumulated on the surface of the photocatalyst, leading to facts that the reaction rate is reduced and overall efficiency cannot meet the requirements.

### SUMMARY

The objective of the present invention is to provide a gas processing module which has a good processing effect on a gas-phase organic compound in a mixed gas.

Another objective of the present invention is to provide a gas processing method which has a good processing effect on a gas-phase organic compound in a mixed gas.

Another objective of the present invention is to provide a gas-phase organic compound processing method which has a good processing effect on a gas-phase organic compound.

The gas processing module of the present invention comprises a cavity, a gas input unit, a light source, a photocatalyst, a liquid input unit, a gas discharge unit and a liquid discharge unit. The gas input unit is communicated with the inside of the cavity and used for supplying a to-be-processed gas comprising a gas-phase organic compound into the cavity. The light source is arranged in the cavity and used for providing a first light. The photocatalyst is arranged in the cavity, and at least a portion of the gas-phase organic compound of the to-be-processed gas which comes into contact with the photocatalyst generates an organic compound product under the action of the photocatalyst when irradiated by the first light. The liquid input unit is communicated with the inside of the cavity and used for providing a solvent to come into contact with the surface of the photocatalyst, and the organic compound product can be dissolved into the solvent, wherein the solubility of the organic compound product in the solvent is higher than that of the gas-phase organic compound in the solvent, or the volatility of the organic compound product in the solvent is lower than that of the gas-phase organic compound in the solvent. A gas discharge unit is communicated with the inside of the cavity and used for discharging the to-be-processed gas which is separated from the photocatalyst and has come into contact with the photocatalyst. A liquid discharge unit is communicated with the inside of the cavity and used for discharging the solvent which is separated from the photocatalyst and contains the organic compound product.

In an embodiment of the present invention, the light source continuously supplies ultraviolet light as the first light.

In an embodiment of the present invention, the gas processing module further comprises a filter unit which is used for allowing the to-be-processed gas to pass.

In an embodiment of the present invention, the photocatalyst is arranged at one side of the filter unit, and the light source and the liquid input unit are arranged outside the filter unit and face the photocatalyst.

In an embodiment of the present invention, a plurality of gas processing modules are arranged and connected in series.

In an embodiment of the present invention, the to-be-processed gas passes through the solvent so that at least a portion of the gas-phase organic compound forms a liquid-phase organic compound, and the liquid-phase organic compound generates the organic compound product under the action of the photocatalyst.

In an embodiment of the present invention, the liquid input unit supplies the solvent in a mode of batches.

In an embodiment of the present invention, the liquid input unit supplies the solvent in a continuous mode.

In an embodiment of the present invention, the flow rate of the solvent flowing through the surface of the photocatalyst is more than or equal to 75.6 L/min·m².

In an embodiment of the present invention, the flow rate of the gas-phase organic compound flowing through the surface of the photocatalyst is less than or equal to 0.7 m/s.

In an embodiment of the present invention, the liquid input unit allows the solvent to be sprayed on the surface of the photocatalyst in a mode of spraying.

In an embodiment of the present invention, the liquid input unit allows the solvent to pass through the surface of the photocatalyst in a mode of reciprocating immersion.

In an embodiment of the present invention, the gas-phase organic compound comprises one or more selected from isopropanol, acetone and toluene.

In an embodiment of the present invention, the gas-phase organic compound does not comprise one or more selected from a polyhalogenated compound, a benzene-ring compound, a polycyclic aromatic hydrocarbon and a long-chain alkane compound.

The gas processing method of the present invention comprises: (S1000) providing a to-be-processed gas comprising a gas-phase organic compound; (S2000) allowing the to-be-processed gas to come into contact with the surface of a photocatalyst so that at least a portion of the gas-phase organic compound generates an organic compound product under the action of the photocatalyst; (S3000) providing a solvent; (S4000) allowing the solvent to come into contact with the photocatalyst to dissolve the organic compound product in the solvent, wherein the solubility of the organic compound product in the solvent is higher than that of the gas-phase organic compound in the solvent, or the volatility of the organic compound product in the solvent is lower than that of the gas-phase organic compound in the solvent; and (S5000) separating the to-be-processed gas which has come into contact with the photocatalyst and the solvent containing the organic compound product from the photocatalyst.

In an embodiment of the present invention, the step S2000 comprises continuously providing an ultraviolet light to irradiate the photocatalyst so that the gas-phase organic compound acts to generate the organic compound product.

In an embodiment of the present invention, the step S2000 comprises allowing the gas-phase compound to act for many times by virtue of the photocatalyst to generate the organic compound product.

In an embodiment of the present invention, the gas processing method further comprises (S3200) allowing the to-be-processed gas to pass through the solvent so that at least a portion of the gas-phase organic compound to form a liquid-phase organic compound; and (S3400) allowing the liquid-phase organic compound to generate the organic compound product under the action of the photocatalyst.

In an embodiment of the present invention, the step S3400 comprises allowing the liquid-phase organic compound to act for many times by virtue of the photocatalyst to generate the organic compound product.

In an embodiment of the present invention, the step S3000 comprises supplying the solvent in a mode of batches.

In an embodiment of the present invention, the step S3000 comprises supplying the solvent in a continuous mode.

In an embodiment of the present invention, the flow rate of the solvent flowing through the surface of the photocatalyst is more than or equal to 75.6 L/min·m².

In an embodiment of the present invention, the flow rate of the gas-phase organic compound flowing through the surface of the photocatalyst is less than or equal to 0.7 m/s.

In an embodiment of the present invention, the step S3000 comprises allowing the solvent to be sprayed on the surface of the photocatalyst in a mode of spraying.

In an embodiment of the present invention, the step S3000 comprises allowing the solvent to flow through the surface of the photocatalyst in a mode of reciprocating immersion.

In an embodiment of the present invention, the gas-phase organic compound comprises one or more selected from isopropanol, acetone and toluene.

In an embodiment of the present invention, the gas-phase organic compound does not comprise one or more selected from a polyhalogenated compound, a benzene-ring compound, a polycyclic aromatic hydrocarbon and a long-chain alkane compound.

The gas-phase organic compound processing method of the present invention comprises: (A1000) providing a gas-phase organic compound; (A2000) allowing the gas-phase organic compound to generate an organic compound product under the action of a photocatalyst; (A3000) providing a solvent; (A4000) allowing the solvent to come into contact with the surface of the photocatalyst to dissolve the organic compound product in the solvent, wherein the solubility of the organic compound product in the solvent is higher than that of the gas-phase organic compound in the solvent, or the volatility of the organic compound product in the solvent is lower than that of the gas-phase organic compound in the solvent; and (A5000) allowing the solvent containing the organic compound product to be separated from the photocatalyst.

In an embodiment of the present invention, the step A2000 comprises continuously supplying an ultraviolet light to irradiate the photocatalyst so that the gas-phase organic compound acts to generate the organic compound product.

In an embodiment of the present invention, the step A2000 comprises allowing the gas-phase organic compound to act for many times by virtue of the photocatalyst to generate the organic compound product.

In an embodiment of the present invention, the gas-phase organic compound processing method further comprises: (A3200) allowing the gas-phase organic compound to pass through the solvent so that at least a portion of the gas-phase organic compound forms a liquid-phase organic compound; and (A3400) allowing the liquid-phase organic compound to generate the organic compound product under the action of the photocatalyst.

In an embodiment of the present invention, the step A3400 comprises allowing the liquid-phase organic compound to act for many times by virtue of the photocatalyst to generate the organic compound product.

In an embodiment of the present invention, the step A1000 comprises providing the gas-phase organic compound together with the solvent.

In an embodiment of the present invention, the step A3000 comprises supplying the solvent in a mode of batches.

In an embodiment of the present invention, the step A3000 comprises supplying the solvent in a continuous mode.

In an embodiment of the present invention, the flow rate of the solvent flowing through the surface of the photocatalyst is more than or equal to 75.6 L/min·m².

In an embodiment of the present invention, the flow rate of the gas-phase organic compound flowing through the surface of the photocatalyst is less than or equal to 0.7 m/s.

In an embodiment of the present invention, the step A3000 comprises allowing the solvent to be sprayed on the surface of the photocatalyst in a mode of spraying.

In an embodiment of the present invention, the step A3000 comprises allowing the solvent to flow through the surface of the photocatalyst in a mode of reciprocating immersion.

In an embodiment of the present invention, the gas-phase organic compound comprises one or more selected from isopropanol, acetone and toluene.

In an embodiment of the present invention, the gas-phase organic compound does not comprise one or more selected from a polyhalogenated compound, a benzene-ring compound, a polycyclic aromatic hydrocarbon and a long-chain alkane compound.

### BRIEF DESCRIPTION OF THE DRAWINGS

FIG. 1A is an exemplary diagram of a gas processing module according to the present invention.

FIG. 1B is a diagram of an AA′ section in FIG. 1A.

FIG. 1C is an exemplary diagram of a spray hole formed in a liquid input unit of a gas processing module according to the present invention.

FIG. 2A is a diagram showing an acetone removal effect with or without washing.

FIG. 2B is a diagram showing isopropanol, acetone and toluene removal effects with washing.

FIG. 3A and FIG. 3B are diagrams showing acetone removal results with no washing, cyclic washing and continuous washing.

FIG. 3C is a diagram showing an acetone removal result when a photocatalyst is continuously rinsed with water in different flows.

FIG. 4 is an exemplary flowchart of a gas processing method according to the present invention.

FIG. 5 and FIG. 6 are different exemplary flowcharts of a gas processing method according to the present invention.

FIG. 7 is an exemplary flowchart of a gas-phase organic compound processing method according to the present invention.

FIG. 8 and FIG. 9 are different exemplary flowcharts of a gas-phase organic compound processing method according to the present invention.

### DETAILED DESCRIPTION

Next, embodiments of connection components disclosed in the present invention will be described through specific embodiments in combination with drawings, and those skilled in the art can understand the advantages and effects of the present invention according to the contents disclosed in the specification. However, the following disclosed contents are not intended to limit the scope of protection of the present invention. Those skilled in the art can implement the present invention in other different embodiments based on different concepts and applications without departing from the spirit of the present invention. In the figures, for clarity, the thicknesses of layers, films, panels, regions and the like have been enlarged. In the entire specification, the same reference number represents the same elements. It should be understood that when an element such as layer, film, district or substrate is referred to as being on another element or connected to another element, it can be directly located on another element or connected with another element, or an intermediate element can also be present. On the contrary, when the element is referred to as “directly located on another element” or “directly connected to” another element, the intermediate element is not present. As used herein, “connection” can refer to physical and/or electrical connection. Also, “electrical connection” or “coupling” is meant to a fact that other elements are present between two elements.

It should be understood that although the terms “first”, “second”, “third” and the like can be used for describing various elements, components, regions, layers and/or parts herein, these elements, components, regions and/or parts should be limited by these terms. These terms are only used for distinguishing an element, component, region or part from another element, component, region or part. Therefore, “first element”, “component”, “region”, “layer” or “part” described below can be referred to as a second element, component, region, layer or part, without departing from the teaching of the present invention.

In addition, relative terms such as “lower”, “bottom” and “upper” or “top” can be used for describing a relationship between an element and another element herein, as shown in the figures. It should be understood that relative terms are intended to include different orientations of devices except orientations shown in the figures. For example, if a device in a figure overturns, it is described as an element at the lower side of other elements will be oriented as located at the upper side of other elements. Therefore, exemplary terms “lower” can include the orientations of “lower” and “upper”, depending on specific orientations in the figures. Similarly, if a device in a figure overturns, it is described as an element “under” or “below” other elements will be oriented as being located above other elements. Therefore, exemplary terms “under” or “below” can include orientations of under and below.

The term “about”, “approximate” or “substantially” used herein include the values and an average value of specific values in an acceptable deviation range determined by persons of ordinary skill in the art, considering that the discussed measurement and specific quantity of errors related to the measurements (i.e., limitation of measurement system). For example, “about” can be within one or more standard deviations of the value, or within ±30%, ±20%, ±10%, ±5% Furthermore, the terms “about”, “approximate”, or “substantially” used in this article can be chosen based on optical properties, etching properties, or other properties to select a more acceptable range of deviations or standard deviations, rather than using a single standard deviation to apply to all properties.

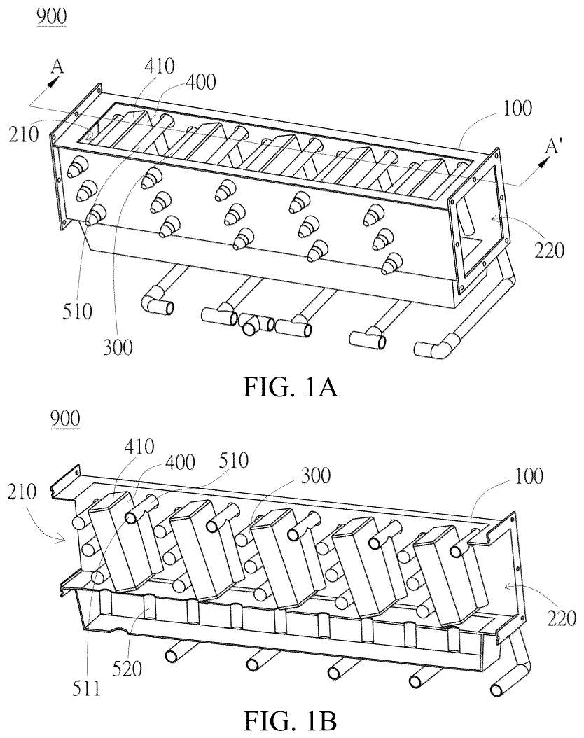

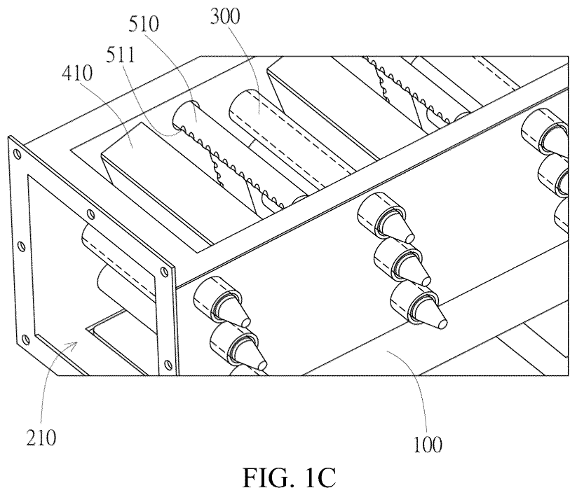

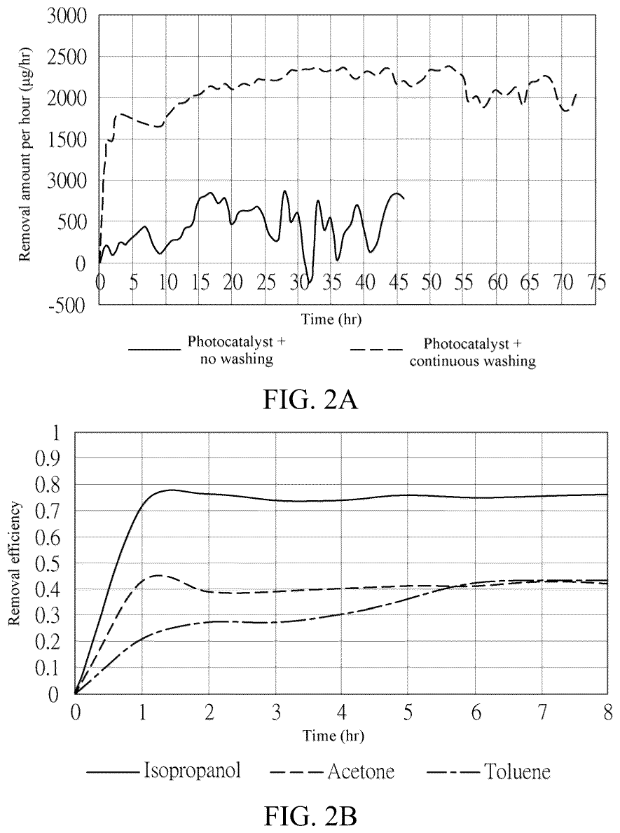

In an example as shown in FIG. 1A, a gas processing module 900 of the present invention comprises a cavity 100, a gas input unit 210, a light source 300, a photocatalyst 400, a liquid input unit 510, a gas discharge unit 220 and a liquid discharge unit 520. In an example, the cavity 100 is made of stainless steel, however, in different examples, the cavity 100 is made of other alloys, metals, metal oxides or non-metal substances such as polymers and glass. The gas input unit 210 is communicated with the inside of the cavity 100 and used for supplying a to-be-processed gas to the cavity 100. Specifically, in an example, the gas input unit 210 is an opening at one side of the cavity 100 or an interface connected with an external pipeline, etc., and the to-be-processed gas can be transported by virtue of a device such as a pump or a fan to pass through the gas input unit 210 to enter the cavity 100.

The to-be-processed gas comprises a gas-phase organic compound. The gas-phase compound comprises volatile organic compounds (VOCs). In an example, the gas-phase compound comprises one or more selected from isopropanol, acetone and toluene. In different examples, to avoid possible efficacy reduction and other reasons, the gas-phase organic compound does not comprise one or more selected from a polyhalogenated compound, a benzene-ring compound, a polycyclic aromatic hydrocarbon and a long-chain alkane compound.

In an example as shown in FIG. 1A, the light source 300 is arranged in the cavity 100 and used for continuously or intermittently providing a first light. The photocatalyst 400 is arranged in the cavity 100, and at least a portion of the gas-phase organic compound of the to-be-processed gas which comes into contact with the photocatalyst 400 can generate an organic compound product under the action of the photocatalyst 400 when irradiated by the first light. More specifically, in an example, the light source 300 is a lamp tube emitting an ultraviolet light with a wavelength of smaller than 400 nm, the reaction module 900 further comprises a filter unit 400 allowing the to-be-processed gas to pass, the photocatalyst 400 is titanium dioxide (TiO₂) placed at one side of the filter unit 410 such as a wind nest ceramic filter screen where light can directly or indirectly irradiate. The gas-phase organic compound is acetone, which can create the reaction of for example the following formula (1) and formula (2) under the action of the photocatalyst 400 when passing through the filter unit 410. In other words, in this example, the organic compound product is formic acid (HCOOH).

CH₃COCH₃→HCOOH+CH₃CHO Formula (1)

CH₃CHO→2HCOOH Formula (2)

However, in different examples, the light source 300 is a light-emitting device emitting a first light with other wavelengths, the photocatalyst 400 is not limited to titanium dioxide, and the organic compound product is acetic acid, etc.

FIG. 1B is a diagram of an AA′ section in FIG. 1A. In an example as shown in FIG. 1B, a liquid input unit 510 is communicated with the inside of the cavity 100 and used for providing the solvent to come into contact with the surface of the photocatalyst 400. The organic compound product can be dissolved in the solvent such as water, wherein the solubility of the organic compound product in the solvent is higher than that of the gas-phase organic compound in the solvent, or the volatility of the organic compound product in the solvent is lower than that of the gas-phase organic compound in the solvent. Specifically, in an example, the liquid input unit 510 can be a pipeline penetrating from the external of the cavity 100, and a solvent is transported by virtue of a device such as a pump or enters the cavity 100 under the action of gravity and comes into contact with the surface of the photocatalyst 400. Where, one end of the pipeline in the cavity 100 can be further arranged in a spray hole 511 and faces the photocatalyst 400, so that the solvent is sprayed on the surface of the photocatalyst 400 in a mode of spraying. In different examples, one end of the pipeline in the cavity 100 cannot face the photocatalyst 400, and the solvent flows in or out of the cavity 100 and flows through the surface of the photocatalyst 400 in a mode of reciprocating immersion. Where, the liquid input unit 510 can supply the solvent in a mode of batches or in a continuous mode, or can allow the solvent to intermittently or continuously flow through the surface of the photocatalyst 400.

In an example as shown in FIG. 1B, a gas discharge unit 220 is communicated with the inside of the cavity 100 and used for discharging a to-be-processed gas which is separated from the photocatalyst 400 and has come into contact with the photocatalyst. Specifically, in an example, the gas discharge unit 220 is an opening at one side of the cavity 100 or an interface connected with the external pipeline, etc., and the to-be-processed gas is transported by virtue of a device such as a pump or a fan to pass through the gas discharge unit 220 to be discharged out of the cavity 100. The liquid discharge unit 520 is communicated with the inside of the cavity 100 and used for discharging a solvent which is separated from the photocatalyst 400 and contains an organic compound product. Specifically, in an example, the liquid discharge unit 520 can be a pipeline penetrating from the external of the cavity 100, and a solvent is transported by virtue of a device such as a pump or leaves from the cavity 100 under the action of gravity.

Further, in an example, the above-mentioned acetone as the gas-phase organic compound can generate formic acid as the organic compound product under the action of the photocatalyst 400, and at least a portion of formic acid is attached to the surface of the photocatalyst 400. In general, formic acid can be subjected to a reaction represented by the following formula (3),

2HCOOH+O₂→2CO₂+2H₂O Formula (3)

to decompose into carbon dioxide and water. However, the rate of this reaction is relatively low, so it is considered as a rate-determining step (RDS). Since the surface of the photocatalyst 400 cannot continue to react with the gas-phase organic compound acetone due to attachment of formic acid, the reaction rate is significantly reduced. Relatively, the present invention provides a solvent to come into contact with the surface of the photocatalyst 400. Since the solubility of the organic compound product (formic acid) in the solvent (water) is higher than that of the gas-phase organic compound (acetone) in the solvent (water), or the volatility of the organic compound product (formic acid) in the solvent (water) is lower than that of the gas-phase organic compound (acetone) in the solvent (water), formic acid attached to the surface of the photocatalyst 400 can be rapidly taken away so that the photocatalyst 400 can continuously react with acetone, thereby greatly promoting the reaction rate. Where, for example, the time for allowing the gas-phase organic compound such as acetone to come into contact with the photocatalyst is longer than the time for reacting with the photocatalyst to form the organic compound product such as formic acid, but shorter than the time for finally generating final reaction products such as carbon dioxide and water after its complete reaction. From different perspectives, the present invention is not intended to accelerate the complete reaction of the gas-phase organic compound, but to utilize the differences between solubilities or volatilities of the gas-phase organic compound and the organic compound product in the solvent to substantially rinse the surface of the photocatalyst 400 with the solvent to take away the organic compound product attached to the surface of the photocatalyst 400, and allow the photocatalyst 400 to continuously react with the gas-phase organic compound under the irradiation of ultraviolet light, so as to greatly promote the reaction rate.

In different examples, the to-be-processed gas can pass through the solvent so that at least a portion of the gas-phase organic compound forms the liquid-phase organic compound, and the liquid-phase organic compound can generate the organic compound product under the action of the photocatalyst. From different perspectives, the to-be-processed gas entering the cavity can allow at least a portion of the gas-phase organic compound in the to-be-processed gas to form the liquid-phase organic compound through washing, and then to similarly generate the organic compound product under the action of the photocatalyst and take away the organic compound product from the surface of the photocatalyst by water.

In examples as shown in FIG. 1A-FIG. 1C, the shape, size, arrangement, relative angle and the like of each element in the gas processing module 900 can be adjusted as needed. In other aspects, a plurality of the gas processing modules 900 are arranged and connected in series, so as to promote the processing effect and/or processing capacity of the gas-phase organic compound.

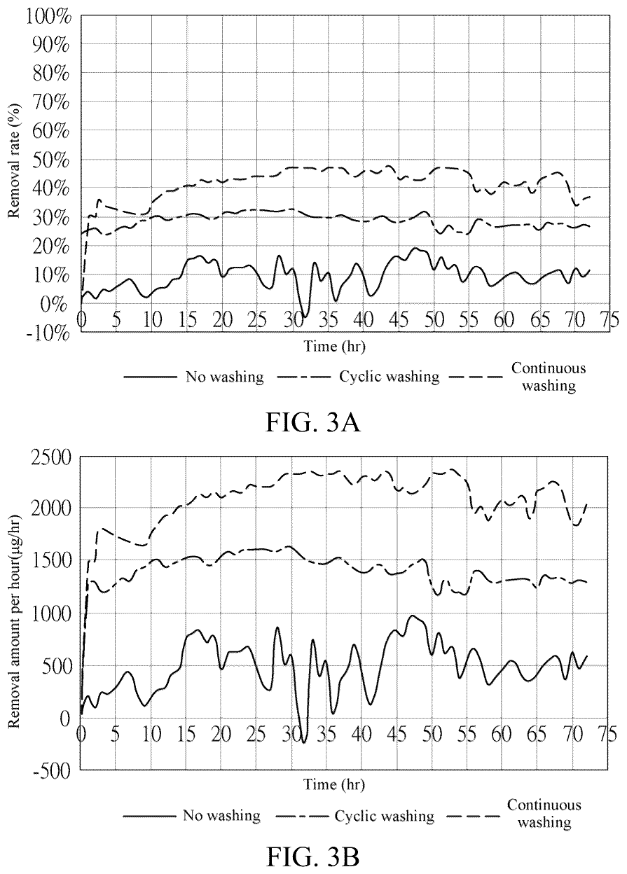

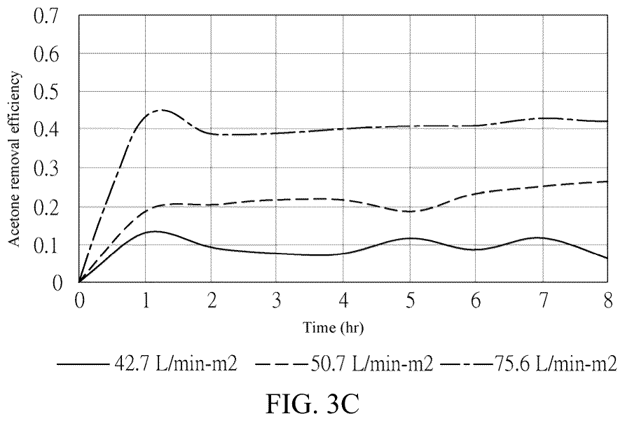

Gas processing module example 1: a substrate having a length of 150 mm, a width of 150 mm, a thickness of 50 mm and a pore size of 4 mm and made of cordierite, mullite, aluminum titanate, silicon carbide, zirconia, silicon nitride or the like is used. A titanium dioxide photocatalyst is arranged on the surface of the substrate, lamp tubes emitting an ultraviolet light with a wavelength of less than 400 nm are arranged in an included angle of 30°. The photocatalyst is irradiated in a lamp tube distance of 150 mm, and a sprinkler head distance is 50 mm. When the flow of the to-be-processed gas is 0.4 m³/min, the results that the to-be-processed gas continuously flows through the photocatalyst with no washing and with water in the flow of 75.6 L/min·m² are as shown in Table 1 and FIG. 2A. It can be seen that the average removal amount and average removal rate of acetone with continuous washing are obviously superior to those with no washing. It can be proved that the gas processing module of the present invention has a better removal effect on the gas-phase organic compound in the mixed gas.

TABLE 1

| | No washing | Washing |
|---|---|---|
| Average input concentration (μg/m³) of acetone | 34.1 | 32.7 |
| Average removal amount (μg/hr) of acetone | 447 | 1964 |
| Average removal efficiency (%) of acetone | 10 | 41 |

In the above gas processing module example 1, the flow of the to-be-processed gas is 0.4 m³/min, and water flows through the photocatalyst in the flow of 75.6 L/min·m². The removal results of isopropanol, acetone and toluene are as shown in FIG. 2B. It can be obviously seen that the gas processing module of the present invention has a good removal effect on isopropanol, acetone and toluene.

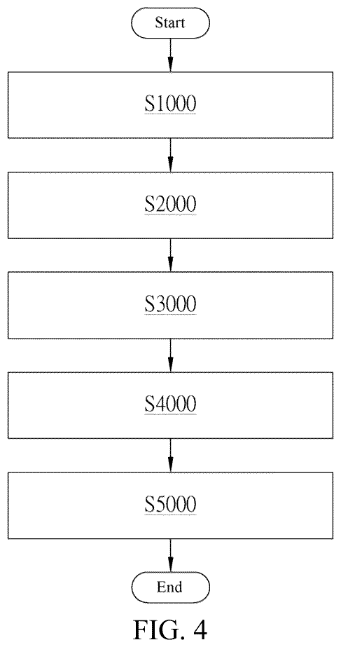

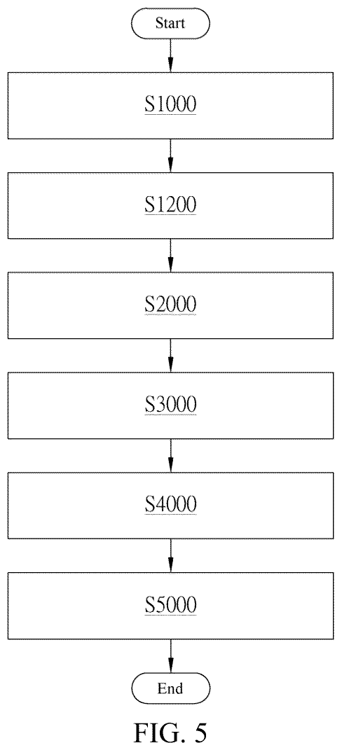

In the above gas processing module example 1, the flow of the to-be-processed gas is 0.4 m³/min. The removal results of acetone with no washing, cyclic washing and continuous washing (the photocatalyst is continuously rinsed with water in the flow of 75.6 L/min·m²) are as shown in FIG. 3A and FIG. 3B. It can be obviously seen that continuous washing has a better effect.

In the above gas processing module example 1, the flow of the to-be-processed gas is 0.4 m³/min, and the photocatalyst is continuously rinsed with water in the flows of 4.27, 50.7 and 75.6 L/min·m². The removal results of acetone are as shown in Table 2 and FIG. 3C. It can be obviously seen that the effect is better when the flow is 75.6 L/min·m².

TABLE 2

| Flow | Average input | Average discharge | Average removal |
|---|---|---|---|
| (L/min · | concentration | concentration | efficiency (%) of |
| m²) | (μg/m³) of acetone | (μg/m³) of acetone | acetone |
| 42.7 | 29.7 | 26.9 | 10 |
| 50.7 | 28.3 | 22.1 | 22 |
| 75.6 | 32.7 | 19.3 | 41 |

In the above gas processing module example 1, the flow rates of the to-be-processed gases are 2.5, 1.5 and 0.7 m/s, and water flows through the photocatalyst in the flow of 75.6 L/min·m². The removal result of acetone is as shown in Table 3. It can be obviously seen that the effect is better when the flow rate is 0.7 m/s.

TABLE 3

| | Average input | Average discharge | Average removal |
|---|---|---|---|
| Gas flow | concentration | concentration | efficiency (%) of |
| rate (m/s) | (μg/m³) of acetone | (μg/m³) of acetone | acetone |
| 2.5 | 34.5 | 26.9 | 22.0 |
| 1.5 | 32.7 | 19.3 | 41.0 |
| 0.7 | 34.1 | 10.2 | 70.1 |

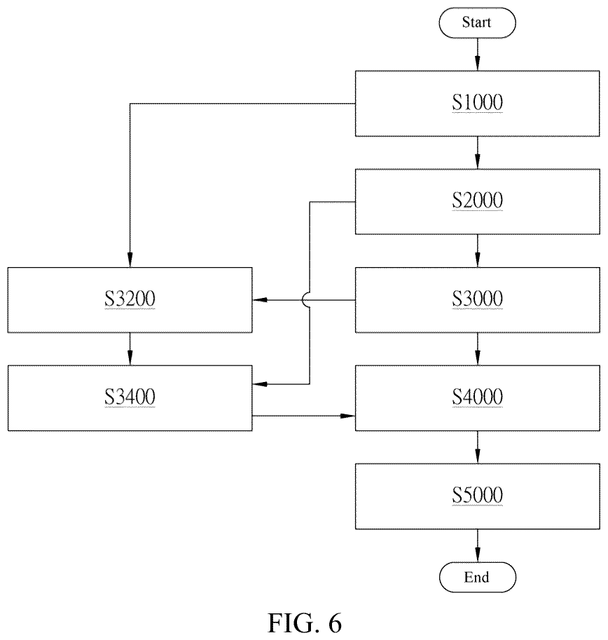

In the exemplary flowchart as shown in FIG. 4, the gas processing method of the present invention comprises the following steps.

Step S1000, providing a to-be-processed gas comprising a gas-phase organic compound. In an example, this step comprises: providing the to-be-processed gas together with a solvent. More specifically, the gas-phase organic compound comprises volatile organic compounds (VOCs). In an example, the gas-phase compound comprises one or more selected from isopropanol, acetone and toluene. In different examples, to avoid possible efficacy reduction and other reasons, the gas-phase organic compound does not comprise one or more selected from a polyhalogenated compound, a benzene-ring compound, a polycyclic aromatic hydrocarbon and a long-chain alkane compound.

Step S2000, allowing the to-be-processed gas to come into contact with the surface of the photocatalyst so that at least a portion of the gas-phase organic compound generates the organic compound product under the action of the photocatalyst. More specifically, in an example, the to-be-processed gas comes into contact with the surface of the photocatalyst 400 as shown in FIG. 1A, so that at least a portion of the gas-phase organic compound generates the organic compound product under the action of the photocatalyst 400. In addition, in an example, this step also comprises: continuously providing an ultraviolet light to irradiate the photocatalyst so that the gas-phase organic compound acts to generate the organic compound product. In another example, this step also comprises: allowing the gas-phase organic compound to act for many times by virtue of the photocatalyst to generate the organic compound product.

Step S3000, providing a solvent to come into contact with the photocatalyst to dissolve the organic compound product in the solvent, wherein the solubility of the organic compound product in the solvent was higher than that of the gas-phase organic compound in the solvent, or the volatility of the organic compound product in the solvent was lower than that of the gas-phase organic compound in the solvent. More specifically, in an example, as shown in FIG. 1A, the solvent comes into contact with the photocatalyst 400 to dissolve the organic compound product in the solvent. This step can comprise supplying the solvent in a mode of batches or in a continuous mode, that is to say, the solvent intermittently or continuously flows through the surface of the photocatalyst 400. The flow rate of the solvent flowing through the surface of the photocatalyst is better, more than or equal to 75.6 L/min·m². The flow rate of the gas-phase organic compound flowing through the surface of the photocatalyst is better, less than or equal to 0.7 m/s. This step can comprise: allowing the solvent to be sprayed on the surface of the photocatalyst in a mode of spraying, or flow through the surface of the photocatalyst in a mode of reciprocating immersion.

Step S4000, separating the to-be-processed gas which comes into contact with the photocatalyst and the solvent containing the organic compound product from the photocatalyst. More specifically, in an example, as shown in FIG. 1B, the to-be-processed gas which comes into contact with the photocatalyst 400 and the solvent containing the organic compound product are separated from the photocatalyst 400. Further, the time for the gas-phase organic compound such as acetone coming into contact with the photocatalyst should be longer than the time for reacting the gas-phase organic compound such as acetone with the photocatalyst to form the organic compound product such as formic acid, but is shorter than the time for finally generating final reaction products such as carbon dioxide and water after its complete reaction.

In the prior art that the photocatalyst decomposes the gas-phase organic compound, and the surface of the photocatalyst cannot continue to react with the gas-phase organic compound due to attachment of the organic compound product, thereby leading to great reduction in reaction rate. Relatively, the present invention provides a solvent to come into contact with the surface of the photocatalyst. Since the solubility of the organic compound product (for example formic acid) in the solvent (for example water) is higher than that of the gas-phase organic compound (for example acetone) in the solvent (for example water), or the volatility of the organic compound product in the solvent is lower than that of the gas-phase organic compound in the solvent, the organic compound product attached to the surface of the photocatalyst can be rapidly taken away by the solvent so that the photocatalyst can continue to react with the gas-phase organic compound, thereby greatly promoting the reaction rate. From different perspectives, the present invention is not intended to accelerate the complete reaction of the gas-phase organic compound, but to utilize the differences between solubilities or volatilities of the gas-phase organic compound and the organic compound product in the solvent to substantially rinse the surface of the photocatalyst with the solvent to take away the organic compound product attached to the surface of the photocatalyst, and allow the photocatalyst to continue to react with the gas-phase organic compound so as to greatly promote the reaction rate.

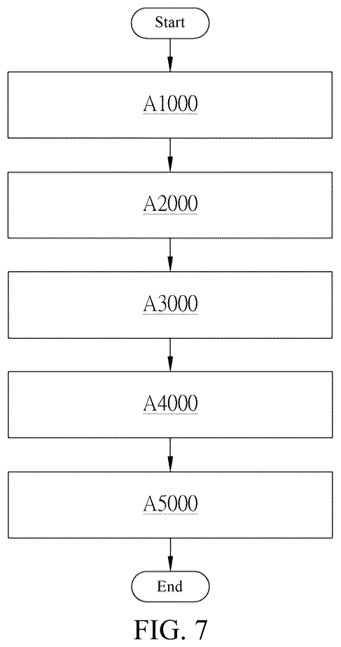

In the exemplary flowchart as shown in FIG. 5, the gas processing method of the present invention further comprises step S1200 where the to-be-processed gas passes through the filter unit. More specifically, as shown in FIG. 1B, the to-be-processed gas passes through the filter unit 410.

In the exemplary flowchart as shown in FIG. 6, the gas processing method of the present invention further comprises step S1500 where the to-be-processed gas passes through the solvent so that at least a portion of the gas-phase organic compound forms the liquid-phase organic compound; and step S2500 where the liquid-phase organic compound generates the organic compound product under the action of the photocatalyst. From different perspectives, the to-be-processed gas entering the cavity can allow at least a portion of the gas-phase organic compound in the to-be-processed gas to form the liquid-phase organic compound through washing, and then to similarly generate the organic compound product under the action of the photocatalyst and take away the organic compound product from the surface of the photocatalyst by water. The step S2500 comprises allowing the liquid-phase organic compound to act for many times by virtue of the photocatalyst to generate the organic compound product.

In the above gas processing method, the to-be-processed gas can comprise one or more gas-phase organic compounds, or can simultaneously process one or more gas-phase organic compounds. In an example, the same concept can be applied to processing of pure gas-phase organic compounds and their mixture.

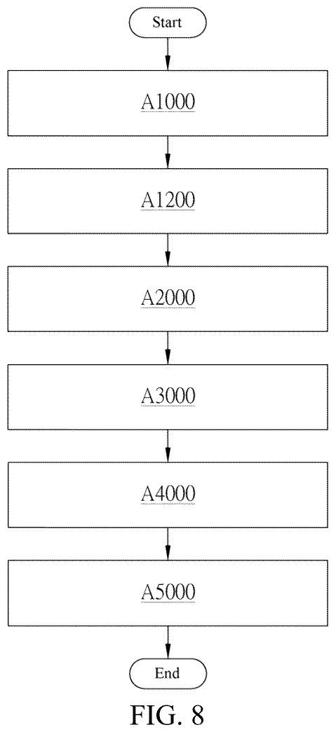

In the exemplary flowchart as shown in FIG. 7, the gas-phase organic compound processing method of the present invention comprises for example the following steps.

Step A1000, providing a gas-phase organic compound. In an example, this step comprises providing the gas-phase organic compound together with the solvent. More specifically, the gas-phase organic compound comprises volatile organic compounds (VOCs). In an example, the gas-phase compound comprises one or more selected from isopropanol, acetone and toluene. In different examples, to avoid possible efficacy reduction and other reasons, the gas-phase organic compound does not comprise one or more selected from a polyhalogenated compound, a benzene-ring compound, a polycyclic aromatic hydrocarbon and a long-chain alkane compound.

Step A2000, allowing the gas-phase organic compound to generate the organic compound product under the action of the photocatalyst. In an example, this step comprises continuously providing an ultraviolet light to irradiate the photocatalyst so that the gas-phase organic compound acts to generate the organic compound product. In another example, this step comprises allowing the gas-phase organic compound to act for many times by virtue of the photocatalyst to generate the organic compound product.

Step A3000, providing the solvent was provided to come into contact with the surface of the photocatalyst to dissolve the organic compound product in the solvent, wherein the solubility of the organic compound product in the solvent is higher than that of the gas-phase organic compound in the solvent, or the volatility of the organic compound product in the solvent is lower than that of the gas-phase organic compound in the solvent. Step A3000 comprises supplying the solvent in a mode of batches or in a continuous mode. The flow rate of the solvent flowing through the surface of the photocatalyst is better, more than or equal to 75.6 L/min·m². The flow rate of the gas-phase organic compound flowing through the surface of the photocatalyst is better, less than or equal to 0.7 m/s. In an example, this step comprises allowing the solvent to be sprayed onto the surface of the photocatalyst in a mode of spraying. In another example, this step comprises allowing the solvent to flow through the surface of the photocatalyst in a mode of reciprocating immersion.

Step A4000, separating the solvent containing the organic compound product from the photocatalyst.

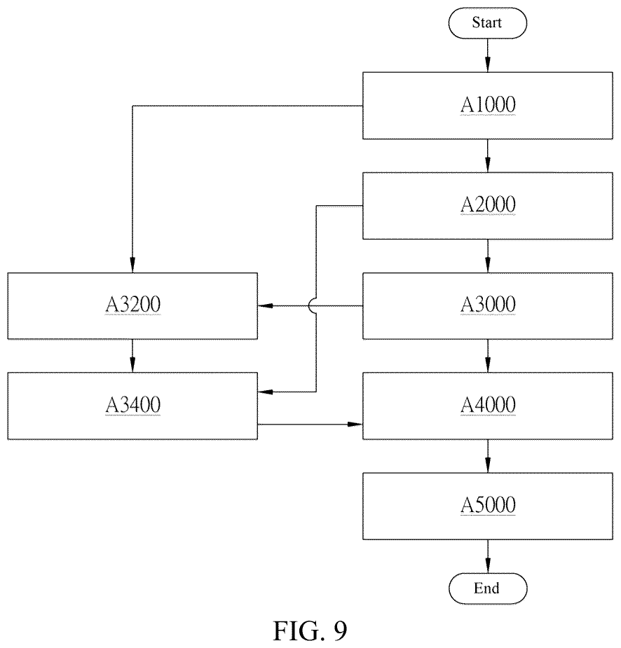

In the exemplary flowchart as shown in FIG. 8, the gas-phase organic compound processing method of the present invention further comprises step A1200 where the gas-phase organic compound passes through the filter unit.

In the exemplary flowchart as shown in FIG. 9, the gas-phase organic compound processing method of the present invention further comprises step A1500 where the gas-phase organic compound passes through the solvent so that at least a portion of the gas-phase organic compound forms the liquid-phase organic compound; and step A2500 where the liquid-phase organic compound generates the organic compound product under the action of the photocatalyst. Step A2500 comprises: the liquid-phase organic compound acts for many times by virtue of the photocatalyst to generate the organic compound product.

Although the above-mentioned descriptions and figures have disclosed preferred embodiments of the present invention, it must be understood that various additions, many modifications and replacements may be used in preferred embodiments of the present invention, but cannot depart from the spirit and scope of the principle defined by the appended claims. Persons of ordinary skill in the art will appreciate that the present invention can be used for modifications of many forms, structures, arrangements, proportions, materials, elements and components. Therefore, the embodiments disclosed herein are deemed as being intended to describe the present invention, but not limit the present invention. The scope of the present invention should the defined by the appended claims, and covers the equivalents, but is not limited thereto.

What is claimed is:

1. A gas processing module, comprising:
a cavity;
a gas input unit communicated with the inside of the cavity and used for supplying a to-be-processed gas comprising a gas-phase organic compound into the cavity;
a light source arranged in the cavity and used for providing a first light;
a photocatalyst arranged in the cavity, wherein at least a portion of the gas-phase organic compound of the to-be-processed gas which comes into contact with the photocatalyst generates an organic compound product under the action of the photocatalyst when irradiated by the first light;
a liquid input unit communicated with the inside of the cavity and used for providing a solvent to come into contact with the surface of the photocatalyst, wherein the organic compound product is dissolved into the solvent, the solubility of the organic compound product in the solvent is higher than that of the gas-phase organic compound in the solvent, or the volatility of the organic compound product in the solvent is lower than that of the gas-phase organic compound in the solvent;
a gas discharge unit communicated with the inside of the cavity and used for discharging the to-be-processed gas which is separated from the photocatalyst and has come into contact with the photocatalyst;
a liquid discharge unit communicated with and used for discharging the solvent which is separated from the photocatalyst and contains the organic compound product.

2. The gas processing module according to claim 1, wherein the light source continuously supplies ultraviolet light as the first light.

3. The gas processing module according to claim 1, further comprising a filter unit which is used for allowing the to-be-processed gas to pass.

4. The gas processing module according to claim 3, wherein the photocatalyst is arranged at one side of the filter unit, and the light source and the liquid input unit are arranged outside the filter unit and face the photocatalyst.

5. The gas processing module according to claim 1, wherein a plurality of gas processing modules are arranged and connected in series.

6. The gas processing module according to claim 1, wherein:
the to-be-processed gas passes through the solvent so that at least a portion of the gas-phase organic compound forms a liquid-phase organic compound through the solvent;
the liquid-phase organic compound generates the organic compound product under the action of the photocatalyst.

7. The gas processing module according to claim 1, wherein the liquid input unit supplies the solvent in a mode of batches.

8. The gas processing module according to claim 1, wherein the liquid input unit supplies the solvent in a continuous mode.

9. The gas processing module according to claim 8, wherein the flow rate of the solvent flowing through the surface of the photocatalyst is more than or equal to 75.6 L/min·m².

10. The gas processing module according to claim 1, wherein the flow rate of the gas-phase organic compound flowing through the surface of the photocatalyst is less than or equal to 0.7 m/s.

11. The gas processing module according to claim 1, wherein the liquid input unit allows the solvent to be sprayed on the surface of the photocatalyst in a mode of spraying.

12. The gas processing module according to claim 1, wherein the liquid input unit allows the solvent to flow through the surface of the photocatalyst in a mode of reciprocating immersion.

13. The gas processing module according to claim 1, wherein the gas-phase organic compound comprises one or more selected from isopropanol, acetone and toluene.

14. The gas processing module according to claim 1, wherein the gas-phase organic compound does not comprise one or more selected from a polyhalogenated compound, a benzene-ring compound, a polycyclic aromatic hydrocarbon and a long-chain alkane compound.

15. A gas processing method, comprising:
(S1000) providing a to-be-processed gas comprising a gas-phase organic compound;
(S2000) allowing the to-be-processed gas to come into contact with the surface of a photocatalyst so that at least a portion of the gas-phase organic compound generates an organic compound product under the action of the photocatalyst;
(S3000) providing a solvent;
(S4000) allowing the solvent to come into contact with the photocatalyst to dissolve the organic compound product into the solvent, wherein the solubility of the organic compound product in the solvent is higher than that of the gas-phase organic compound in the solvent, or the volatility of the organic compound product in the solvent is lower than that of the gas-phase organic compound in the solvent; and
(S5000) separating the to-be-processed gas which has come into contact with the photocatalyst and the solvent containing the organic compound product from the photocatalyst.

16. The gas processing method according to claim 15, wherein the step S2000 comprises continuously providing an ultraviolet light to irradiate the photocatalyst so that the gas-phase organic compound acts to generate the organic compound product.

17. The gas processing method according to claim 15, further comprising:
(S1200) allowing the to-be-processed gas to pass through a filter unit.

18. The gas processing method according to claim 15, wherein the step S2000 comprises allowing the gas-phase compound to act for many times by virtue of the photocatalyst to generate the organic compound product.

19. The gas processing method according to claim 15, further comprising:
(S3200) allowing the to-be-processed gas to pass through the solvent so that at least a portion of the gas-phase organic compound to form a liquid-phase organic compound; and
(S3400) allowing the liquid-phase organic compound to generate the organic compound product under the action of the photocatalyst.

20. The gas processing method according to claim 19, wherein the step S3400 comprises allowing the liquid-phase organic compound to act for many times by virtue of the photocatalyst to generate the organic compound product.

21. The gas processing method according to claim 15, wherein the step S3000 comprises supplying the solvent in a mode of batches.

22. The gas processing method according to claim 15, wherein the step S3000 comprises supplying the solvent in a continuous mode.

23. The gas processing method according to claim 22, wherein the flow rate of the solvent passing through the surface of the photocatalyst is more than 75.6 L/min·m².

24. The gas processing method according to claim 15, wherein the flow rate of the gas-phase organic compound passing through the surface of the photocatalyst is less than or equal to 0.7 m/s.

25. The gas processing method according to claim 15, wherein the step S3000 comprises allowing the solvent to be sprayed on the surface of the photocatalyst in a mode of spraying.

26. The gas processing method according to claim 15, wherein the step S3000 comprises allowing the solvent to be sprayed on the surface of the photocatalyst in a mode of reciprocating immersion.

27. The gas processing method according to claim 15, wherein the gas-phase organic compound comprises one or more selected from isopropanol, acetone and toluene.

28. The gas processing method according to claim 15, wherein the gas-phase organic compound does not comprise one or more selected from a polyhalogenated compound, a benzene-ring compound, a polycyclic aromatic hydrocarbon and a long-chain alkane compound.

29. A gas-phase organic compound processing method, comprising:
(A1000) providing a gas-phase organic compound;
(A2000) allowing the gas-phase organic compound to generate an organic compound product under the action of a photocatalyst;
(A3000) providing a solvent;
(A4000) allowing the solvent to come into contact with the surface of the photocatalyst to dissolve the organic compound product in the solvent, wherein the solubility of the organic compound product in the solvent is higher than that of the gas-phase organic compound in the solvent, or the volatility of the organic compound product in the solvent is lower than that of the gas-phase organic compound in the solvent; and
(A5000) allowing the solvent containing the organic compound product to be separated from the photocatalyst.

30. The gas-phase organic compound processing method according to claim 29, wherein the step A2000 comprises continuously supplying an ultraviolet light to irradiate the photocatalyst so that the gas-phase organic compound acts to generate the organic compound product.

31. The gas-phase organic compound processing method according to claim 29, wherein the step A2000 comprises allowing the gas-phase organic compound to act for many times by virtue of the photocatalyst to generate the organic compound product.

32. The gas-phase organic compound processing method according to claim 29, further comprising:
(A3200) allowing the gas-phase organic compound to pass through the solvent so that at least a portion of the gas-phase organic compound forms a liquid-phase organic compound;
(A3400) allowing the liquid-phase organic compound to generate the organic compound product under the action of the photocatalyst.

33. The gas processing method according to claim 32, wherein the step A3400 comprises allowing the liquid-phase organic compound to act for many times by virtue of the photocatalyst to generate the organic compound product.

34. The gas-phase organic compound processing method according to claim 29, wherein the step A1000 comprises providing the gas-phase organic compound together with the solvent.

35. The gas-phase organic compound processing method according to claim 29, wherein the step A3000 comprises supplying the solvent in a mode of batches.

36. The gas-phase organic compound processing method according to claim 29, wherein the step A3000 comprises supplying the solvent in a continuous mode.

37. The gas-phase organic compound processing method according to claim 36, wherein the flow rate of the solvent flowing through the surface of the photocatalyst is more than 75.6 L/min·m².

38. The gas-phase organic compound processing method according to claim 29, wherein the flow rate of the gas-phase organic compound flowing through the surface of the photocatalyst is less than or equal to 0.7 m/s.

39. The gas-phase organic compound processing method according to claim 29, wherein the step A3000 comprises allowing the solvent to be sprayed on the surface of the photocatalyst in a mode of spraying.

40. The gas-phase organic compound processing method according to claim 29, wherein the step A3000 comprises allowing the solvent to flow through the surface of the photocatalyst in a mode of reciprocating immersion.

41. The gas-phase organic compound processing method according to claim 29, wherein the gas-phase organic compound comprises one or more selected from isopropanol, acetone and toluene.

42. The gas-phase organic compound processing method according to claim 29, wherein the gas-phase organic compound does not comprise one or more selected from a polyhalogenated compound, a benzene-ring compound, a polycyclic aromatic hydrocarbon and a long-chain alkane compound.
